(19) United States
(12) Patent Application Publication
(10) Pub. No.: US 2011/0312226 A1
(43) Pub. Date: Dec. 22, 2011

(54) ELECTRICAL CONNECTOR WITH A POSITION BLOCK

(75) Inventor: JIE ZHANG, Shenzhen (CN)

(73) Assignee: HON HAI PRECISION INDUSTRY CO., LTD., Tu-Cheng (TW)

(21) Appl. No.: 12/957,428

(22) Filed: Dec. 1, 2010

(30) Foreign Application Priority Data
Jun. 21, 2010 (CN) 201020230702.6

(51) Int. Cl. H01R 24/00

(52) U.S. Cl. 439/660

(57) ABSTRACT

An electrical connector includes an insulative housing and a plurality of terminal pins inserted into the insulative housing. The insulative housing defines a plurality of receiving passageways and a position groove communicating with the receiving passageways. Each terminal pin comprises a base portion of pole shape and a pair of wing portions extending out of two opposite side faces of the base portion. The electrical connector further includes a position block retained in the position groove. A bottom wall of the position groove and the position block abut against two opposite sides of the wing portions.

### BACKGROUND OF THE INVENTION

1. Field of the Invention

The present invention relates to an electrical connector, and more particularly to an electrical connector with a position block securing contacts to an insulative housing.

2. Description of the Related Art

U.S. Pat. No. 4,968,263 issued on Nov. 6, 1990 discloses an electrical connector. The electrical connector comprises an insulative housing defining a plurality of pin-receiving through holes and a plurality of terminal pins received in the through holes. The terminal pins have spaced enlargements located on two opposite sides of the insulative housing to retain the terminal pins in the through holes. The spaced enlargements make a manufacture process of the electrical connector complicated.

In view of the above, a new electrical connector that overcomes the above-mentioned disadvantages is desired.

### SUMMARY OF THE INVENTION

Accordingly, an object of the present invention is to provide an electrical connector with a position block securing contacts to an insulative housing.

To fulfill the above-mentioned object, an electrical connector comprises an insulative housing and a plurality of terminal pins inserted into the insulative housing. The insulative housing defines a plurality of receiving passageways and a position groove communicating with the receiving passageways. Each terminal pin comprises a base portion of pole shape and a pair of wing portions extending out of two opposite side faces of the base portion. The electrical connector further comprises a position block retained in the position groove. A bottom wall of the position groove and the position block abut against two opposite sides of the wing portions.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector of the present invention;

FIG. 2 is an exploded view of the electrical connector of FIG. 1; and

FIG. 3 is a cross sectional view of the electrical connector taken along line 3-3 in the FIG. 1.

### DETAILED DESCRIPTION OF THE PREFERRED EMBODIMENT OF THE INVENTION

Reference will now be made to the drawings to describe the present invention in detail.

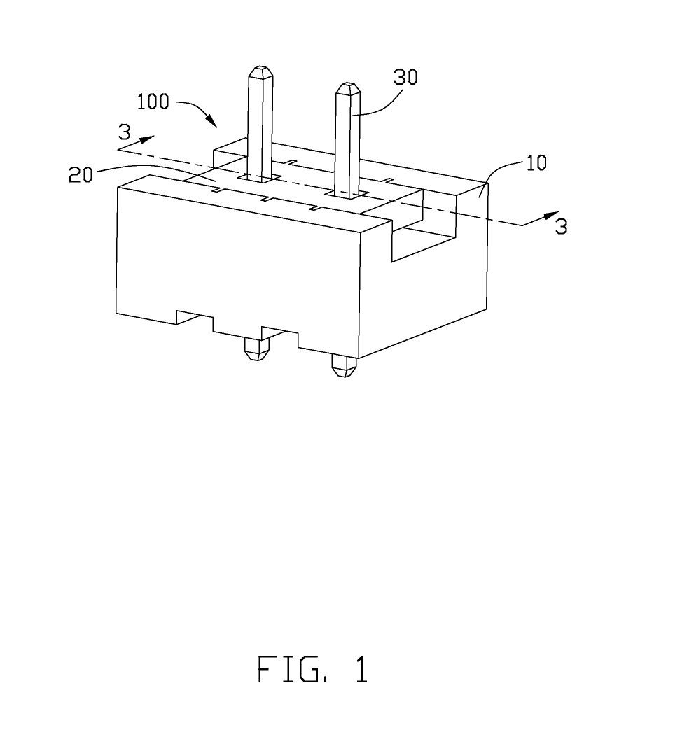

Referring to FIG. 1, an electrical connector 100 comprises an insulative housing 10 of rectangle shape, a position block 20 retained in the insulative housing 10 and a plurality of terminal pins 30 simultaneity received in the insulative housing 10 and the position block 20.

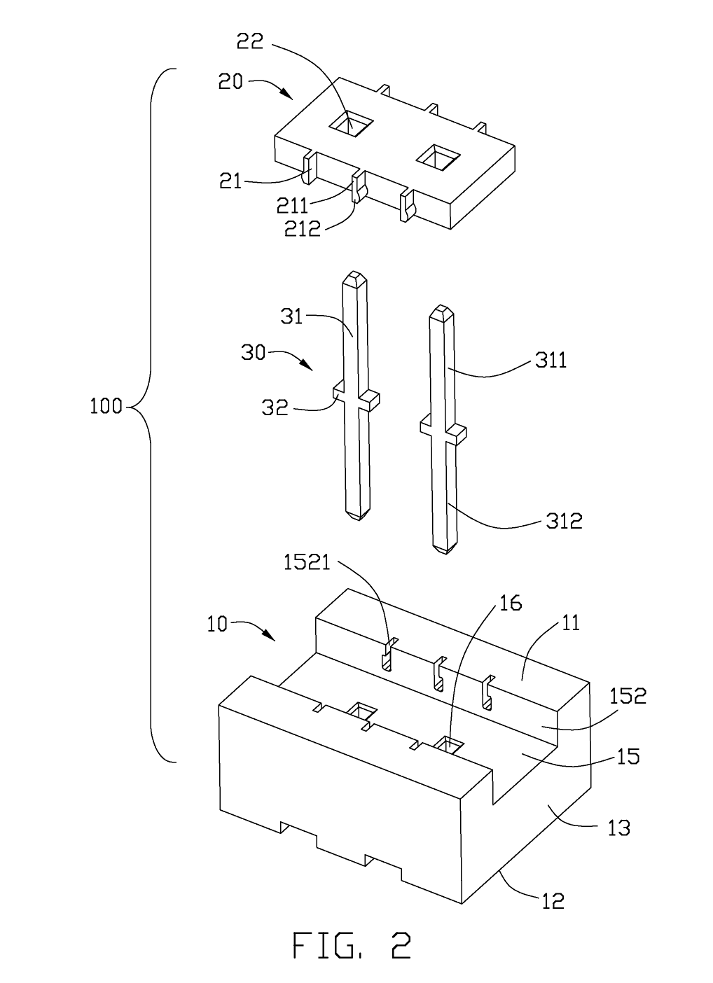

Referring to FIG. 2, the insulative housing 10 defines a mating face 11 and a mounting face 12 opposite to the mating face 11. The insulative housing 10 defines a plurality of receiving passageways 16 running through the mating face 11 and the mounting face 12 and a position groove 15 sinking downwards from the mating face 11. The position groove 15 runs through a pair of opposite side faces 13 bridging the mating face 11 and the mounting face 12 and defines two opposite side walls 152 respectively forming a plurality of retaining grooves 1521. The retaining grooves 1521 are configured with same shape and at least two retaining grooves 1521 are mirror symmetrical. The retaining grooves 1521 communicate with the position groove 15 and run through the mating face 11. The receiving passageways 16 are perpendicular with the position groove 15 and communicate with the position groove 15 and are configured with pole shape.

Each terminal pin 30 comprises a base portion 31 of pole shape and a pair of wing portions 32 perpendicularly extending from two opposite sides of the base portion 31. The base portion 31 is divided with two parts, one part served as a soldering portion 312 extending out of the mounting face 12 and welding to a print circuit board (not shown) and the other part served as a contacting portion 311 extending out of the mating face 11 and connecting with a mating electrical connector (not shown). The terminal pins 30 are inserted into the receiving passageways 16 in an up-to-down direction.

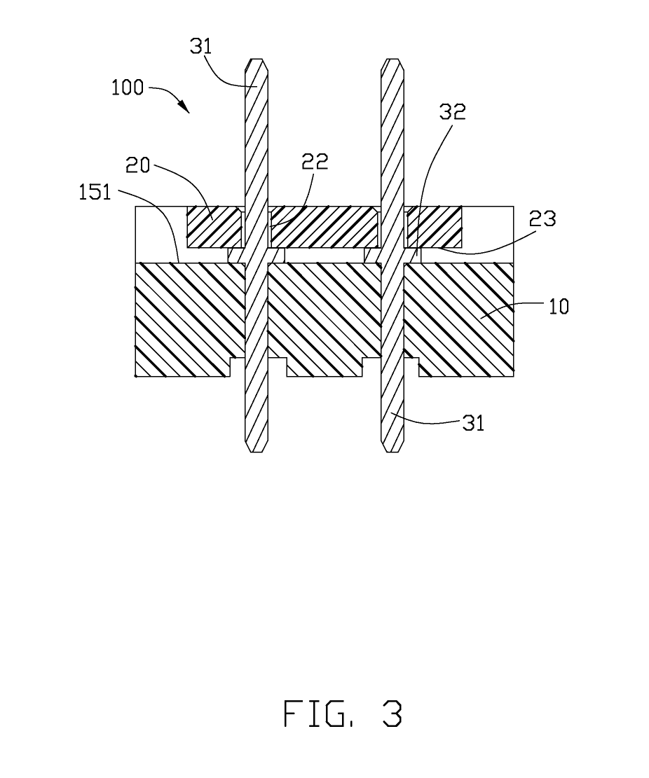

The position block 20 is inserted in the position groove 15 along the up-to-down direction after the terminal pins 30 are retained in the receiving passageways 16. The position block 20 is configured with rectangle shape and comprises a plurality of retaining portions 21 perpendicularly extending from two opposite sides thereof and secured in the retaining grooves 1521. Referring to FIG. 3, the wing portions 32 abut against a bottom face 151 of the position groove 15 and a lower face 23 of the position block 20 abuts against the wing portions 32, so the wing portions 32 are sandwiched between two confronting faces of the insulative housing 10 and the position block 20 in the up-to-down direction. The retaining portion 21 defines a large portion 212 adjacent to the lower face 23 of the position block 20. The large portion 212 has a larger dimension than the other structure 211 thereof to engage with the retaining groove 1521 to secure the position block 20 to the insulative housing 10. The large portion 212 is configured with arc shape to guide the retaining portion 21 into the retaining groove 1521. The retaining grooves 1521 have the same shape with the retaining portions 21. The position block 20 defines a plurality of receiving cavities 22 running through two opposite faces thereof and corresponding to the receiving passageways 16. The receiving cavities 22 have a larger dimension than the terminal pins 30 to simply an assembly process of the electrical connector 100. The position block 20 is secured to the insulative housing 10 just by the retaining portions 21 and the retaining grooves 1521.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing defining a plurality of receiving passageways and a position groove communicating with the receiving passageways;
a plurality of terminal pins inserted into the receiving passageways and each terminal pin comprising a base portion of pole shape and a pair of wing portions extending out of two opposite side faces of the base portion;
wherein the electrical connector further comprises a position block retained in the position groove, a bottom wall of the position groove and the position block abut against two opposite sides of the wing portions.

2. The electrical connector as claimed in claim 1, wherein the wing portions are perpendicular with the base portion.

3. The electrical connector as claimed in claim 2, wherein the receiving passageways run through a mating face and a mounting face opposite to the mating face, the position groove sinks downwards from the mating face.

4. The electrical connector as claimed in claim 3, wherein the base portion is divided with two parts by the wing portion, one part is served as a soldering portion extending out of the mounting face and the other part is served as a contacting portion extending out of the mating face.

5. The electrical connector as claimed in claim 1, wherein two opposite side walls of the position groove define a plurality of retaining grooves communicating with the position groove and the position block perpendicularly protrudes a plurality of retaining portions secured in the retaining grooves.

6. The electrical connector as claimed in claim 5, wherein the retaining grooves have same shapes and at least two retaining grooves are mirror symmetrical.

7. The electrical connector as claimed in claim 5, wherein the retaining portion defines a large portion of arc shape and the large portion has a larger dimension than the other structure of the retaining portion.

8. An electrical connector comprising:
an insulative housing defining a position groove therein;
a position block inserted and retained in the position groove along a first direction;
at least one terminal pin retained in a corresponding receiving passageway with a contacting portion exposing to a mating face of electrical connector and with a soldering portion exposing to a mounting face opposite to the mating face of the electrical connector;
wherein the at least one terminal pin defines at least one wing portion sandwiched between two opposite confronting faces of the insulative housing and the position block in the first direction.

9. The electrical connector as claimed in claim 8, wherein the position block has retaining portions at two opposite sides thereof, each retaining portion has an arc-shaped large portion adjacent to the confronting face of the position block, the insulative housing defines corresponding retaining grooves engaging with the retaining portions to secure the position block in the position groove.

10. The electrical connector as claimed in claim 9, wherein the retaining grooves run through the mating face of the electrical connector and communicate with the position groove.

11. The electrical connector as claimed in claim 10, wherein the position block is inserted in the position groove along the first direction after the said terminal pin is retained in the insulative housing.

12. The electrical connector as claimed in claim 11, wherein the retaining grooves are arranged in two rows and located at two opposite sides of the position groove.

13. An electrical connector comprising:
an insulative housing defining opposite mating face and mounting face in a vertical direction;
a positioning groove downwardly recessed from the mating face;
a plurality of receiving passageways extending through the mounting face and into the positioning groove in said vertical direction;
a plurality of terminal pins each including a lower part downwardly extending into the receiving passageway, an upper part upwardly extending into the positioning groove and at least one laterally extending wing portion located between the lower part and the upper part; and
a positioning block positioned in the positioning groove and defining receiving a plurality of cavities aligned with the receiving passageways, respectively, and receiving the corresponding upper parts therein, respectively; wherein
said at least one laterally extending wing portion is sandwiched between the positioning block and the housing in said vertical direction.

14. The electrical connector as claimed in claim 13, wherein said positioning block and said housing define structure to allow the positioning block to be assembled into the positioning groove in said vertical direction.

15. The electrical connector as claimed in claim 14, wherein said positioning block includes a plurality of retaining structures on two exterior sides, and the housing includes a plurality of retaining devices on two interior sides facing toward the positioning groove for locking to the corresponding retaining structures.

16. The electrical connector as claimed in claim 15, wherein said retaining structures define protrusions and the retaining devices define the retaining grooves receiving the corresponding protrusions, respectively.

17. The electrical connector as claimed in claim 13, wherein a top face of the positioning block is flush with the mating face.

18. The electrical connector as claimed in claim 17, wherein the upper parts of the terminal pins extend upwardly above the top face.
